(19) United States
(12) Patent Application Publication
(10) Pub. No.: US 2018/0211281 A1
(43) Pub. Date: Jul. 26, 2018

(54) Image Similarity Determination of Paths to Control Digital Content Output

(71) Applicant: Adobe Systems Incorporated, San Jose, CA (US)

(72) Inventors: Peter Raymond Fransen, Soquel, CA (US); Christine Xuan Phan, University Place, WA (US)

(73) Assignee: Adobe Systems Incorporated, San Jose, CA (US)

(21) Appl. No.: 15/416,856

(22) Filed: Jan. 26, 2017

(51) Int. Cl. G06Q 30/02; H04W 4/02

(52) U.S. Cl. CPC G06Q 30/0261; H04W 4/02

(57) ABSTRACT

Techniques and systems are described in which an image similarity determination of paths is used to control digital content output. In one example, a plurality of coordinates is received that represent a plurality of physical locations within a physical environment. A digital image is then generated having a path that describes the plurality of coordinates. The path of the generated digital image is compared to a plurality of reference paths described by respective ones of a plurality of reference digital images, e.g., through image similarity. An item of digital content is selected based at least in part on the comparison. Output is then controlled of the selected item of the digital content.

### BACKGROUND

Movement of users from location to location in the real world may be used to provide insight into the intentions and desires of the users. For example, users may move between physical locations within a physical store, mall, amusement part, and so on. Based on this movement, insight may be gained by service provider systems to provide digital content to the users that has an increased likelihood of being of interest, such as digital marking content including advertisements.

Conventional techniques used to do so by service provider systems typically rely on GPS coordinates, which focus on user location at particular points of interest. For instance, conventional techniques employed by service provider systems focus on nearness of users to particular points of interest, such as a store, restaurant, and so forth. While this may provide insight to the service provider systems into potential intentions and desires of users while located at these particular points of interest, these conventional techniques ignore potential insight that may be gained by the service provider systems based on “how” users progressed from one location to another.

### SUMMARY

Techniques and systems are described to control digital content output by a service provider system based on a path that is generated to describe movement within a physical environment, e.g., movement of a client device associated with a user. The path is used by the service provider system to infer meaningful context of the user, such as how meandering or direct the path is with respect to a destination, rather than simply noting where the user is located at the destination as performed by conventional techniques. Through this inferred context, the service provider system may gauge a strength of a user's intent in visiting a destination, how engaged the user is with a given space and environment, and so on. Thus, the path supports increased richness in description of the user within the physical environment over conventional point-of-interest based techniques.

Additionally, these techniques may be performed with reduced consumption of computational resources by leveraging image similarity techniques. For example, image similarity techniques may be used by a service provider system to compare and overall shape and contours of the paths to determine similarity of paths to each other, rather than directly rely on nearness to particular coordinates. As a result, the image similarity techniques are applicable to paths regardless of actual physical location within a physical environment, which is not possible using conventional point-of-interest and coordinate-based techniques. This may be used to control output of a variety of different types of digital content by the service provider system, such as to target digital marketing content (e.g., advertisements), provide directions, and so forth.

In one example, coordinates are collected by a service provider system from a client device associated with a user, such as from a global positioning system device (GPS device) included in a smart phone, wearable, and so on of the user. The coordinates are used by the service provider system to generate a user path (i.e., plot the path) in a digital image from these coordinates, such as by leveraging a time series of locations journeyed to by the user and client device within a physical environment.

The user path is then compared by the service provider system to a plurality of reference paths within reference digital images. Based on this comparison, the service provider system controls communication of digital content to the user. The service provider system, for instance, may determine that the input path is similar to a reference path in a reference digital image indicating that a corresponding user is likely lost, e.g., is circular, self-intersecting, and so on. The service provider system may then be triggered to provide directions to the user based on this comparison. In another example, the service provider system determines that the input path is similar to a reference path corresponding to a particular segment of a user population. The service provider system may then target digital marketing content (e.g., advertisements) based on this particular segment that have an increased likelihood of being of interest to the user and thus an increased likelihood of resulting in conversion. Further, through use of image similarity techniques the comparison may be performed with increased accuracy and reduced consumption of computational resource than techniques that directly examine the coordinates.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The detailed description is described with reference to the accompanying figures. Entities represented in the figures may be indicative of one or more entities and thus reference may be made interchangeably to single or plural forms of the entities in the discussion.

FIG. 1 is an illustration of an environment in an example implementation that is operable to employ image similarity path-based techniques described herein.

FIG. 2 depicts a system in an example implementation showing operation of a path manager module of FIG. 1 in greater detail as controlling output of digital content based on image similarity of a path to a plurality of reference paths.

FIG. 3 depicts an example of a physical journey taken by a user through a physical environment configured as an amusement park that serves as a basis to form the path in the digital image.

FIG. 4 depicts an example implementation of physical journeys taken by other users that serve as a basis to form reference paths that are compared to the path taken by the user in FIG. 3.

FIG. 5 depicts an example implementation of image similarity comparisons performed by the similarity determination module 130 of FIG. 1 of the path to the reference paths of FIGS. 3 and 4.

FIG. 6 is a flow diagram depicting a procedure in an example implementation in which output of digital content is controlled based on image similarity of a path to a plurality of reference paths.

FIG. 7 depicts a system in an example implementation in which a synthesized path is compared to paths taken of real world movement to determine image similarity, one to another.

FIG. 8 is a flow diagram depicting a procedure in an example implementation in which a plurality of digital images is collected that describe paths describing actual physical movement and compared with a synthesized path to determine image similarity.

FIG. 9 illustrates an example system including various components of an example device that can be implemented as any type of computing device as described and/or utilize with reference to FIGS. 1-8 to implement embodiments of the techniques described herein.

### DETAILED DESCRIPTION

Overview

User movement between locations in a physical environment may give a service provider system insight into potential desires of the user. Conventional techniques to do so, however, rely on predefined points of interest and thus not on an overall shape of a path taken by the user in the physical environment. As such, conventional techniques do not address this potentially useful information and as a result provide limited insight into the potential desires of the user. Further, conventional techniques employed by service provider systems directly employ physical coordinates that describe the user movement and thus require significant computational resources and mathematic algorithms to gain even this limited insight.

Techniques and systems are described to generate a path by a service provider system in a digital image based on coordinates that describe movement of a user within a physical environment. This path is then compared by the service provider system with reference paths in a plurality of reference digital images to determine image similarity, one to another. Image similarity may be determined in a variety of ways by the service provider system, such as through overlap shape detection or individual contour detection including fuzzy hashing, shape and line matching, and so forth.

In this way, representation of the path in an image space as opposed to coordinate space may be used to infer meaningful context based on the contour or shape of the path, regardless of actual location within the physical environment. For example, paths exhibiting loops or repetitive zig-zag patterns may indicate that a corresponding user is likely lost and thus trigger the service provider system to provide digital content that includes directions. Thus, in this example the shape of the paths, regardless of actual physical location, is indicative of the scenario which may then trigger the service provider system to obtain directions for the user, e.g., to infer a likely destination and then directions to that destination based on this trigger. Such an inference is not possible in conventional techniques that directly rely on coordinates and thus actual physical location of the user within a physical environment.

In another example, the paths are used by the service provider system to control communication of digital marketing content. The reference digital images including respective reference paths above, for instance, may be used to define segments of a user population that are receptive to particular items of digital marketing content, e.g., advertisements. In an amusement park example, direct movement of a first user from an entrance to a particular ride associated with a movie may indicate that the user is interested in both that ride and movie. From this, the service provider system may send advertisements relating to that ride and/or movie, e.g., movie related merchandise, opportunities to purchase the movie, etc.

A second user, on the other hand, may also move from the entrance to the particular ride, but takes a meandering route to do so. From this, the service provider system may send more generalized advertisements, e.g., food and drink offers, suggestions for other rides, and so on. In this way, the service provider system may address these users differently, which is not possible using conventional techniques. This may also be used to support a variety of other functionality, such as to enable an operator of the service provider system to manually specify a path and compare this path with real world examples in order to gain insight into how the users actually interact with the physical environment. Further discussion of these and other examples is included in the following sections and shown in corresponding figures.

Term Examples

“Digital content” includes content that is configured to be rendered by a device, such as digital images, digital audio, digital multimedia, and so forth. As such, digital content may take a variety of forms, including digital marketing content including advertisements, banner ads, notifications, and so forth.

“Coordinates” are used to describe locations with a physical environment in the real world. Coordinates may be configured and originated in a variety of ways, such as global positioning system coordinates, coordinates obtained through triangulation (e.g., via Wi-Fi, cell towers), and so forth.

Digital images are configured to be rendered by a computing device, e.g., printed by a printer, displayed by a display device using pixels, and so forth. Accordingly, paths generated within a digital image are also configured to be rendered, and when generated from coordinates serve to transform user locations from a coordinate space to an image space.

“Image Similarity” defines an amount of similarity of images to each other, which in a path context involves similarity in a shape and contours of paths to each other. Examples of techniques to determine image similarity include overlap shape detection and individual contour detection, such as fuzzy hashing, shape and line matching, and image moments, e.g., a weighted average known as a “moment” of intensities of pixels of a digital image which serves as a basis for comparison.

In the following discussion, an example environment is first described that may employ the techniques described herein. Example procedures are also described which may be performed in the example environment as well as other environments. Consequently, performance of the example procedures is not limited to the example environment and the example environment is not limited to performance of the example procedures.

Example Environment

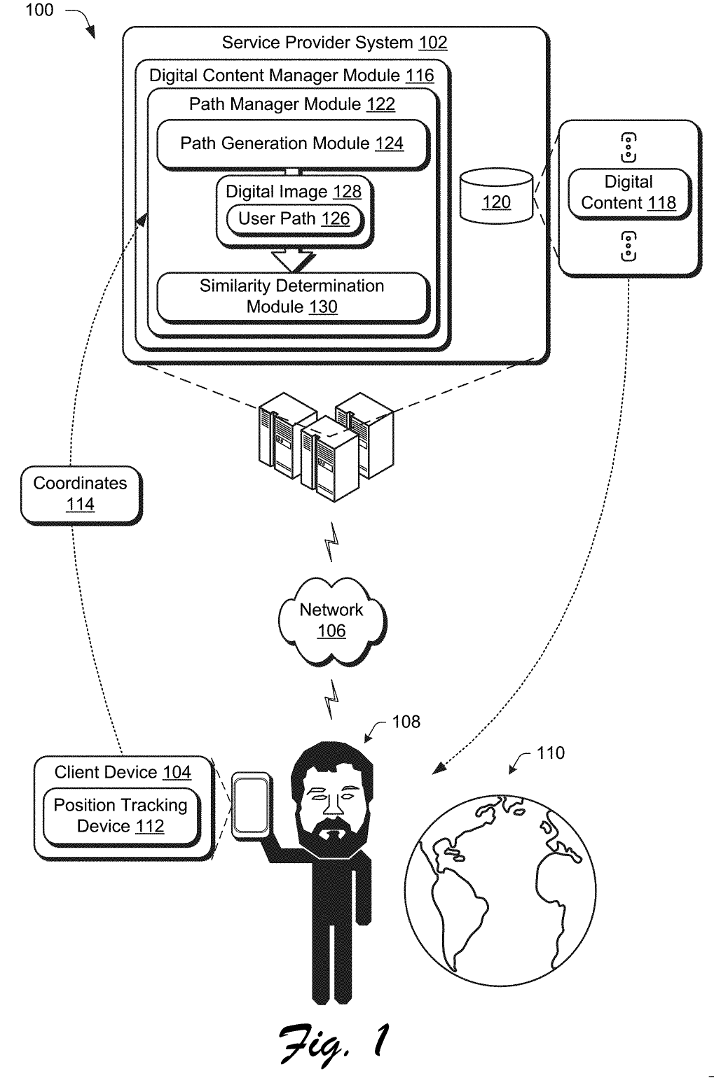

FIG. 1 is an illustration of a digital medium environment 100 in an example implementation that is operable to employ path and image similarity techniques described herein. The illustrated environment 100 includes a service provider system 102 and a client device 104 that are communicatively coupled, one to another, via a network 106. Computing devices that implement the service provider system 102 and client device 104 may be configured in a variety of ways.

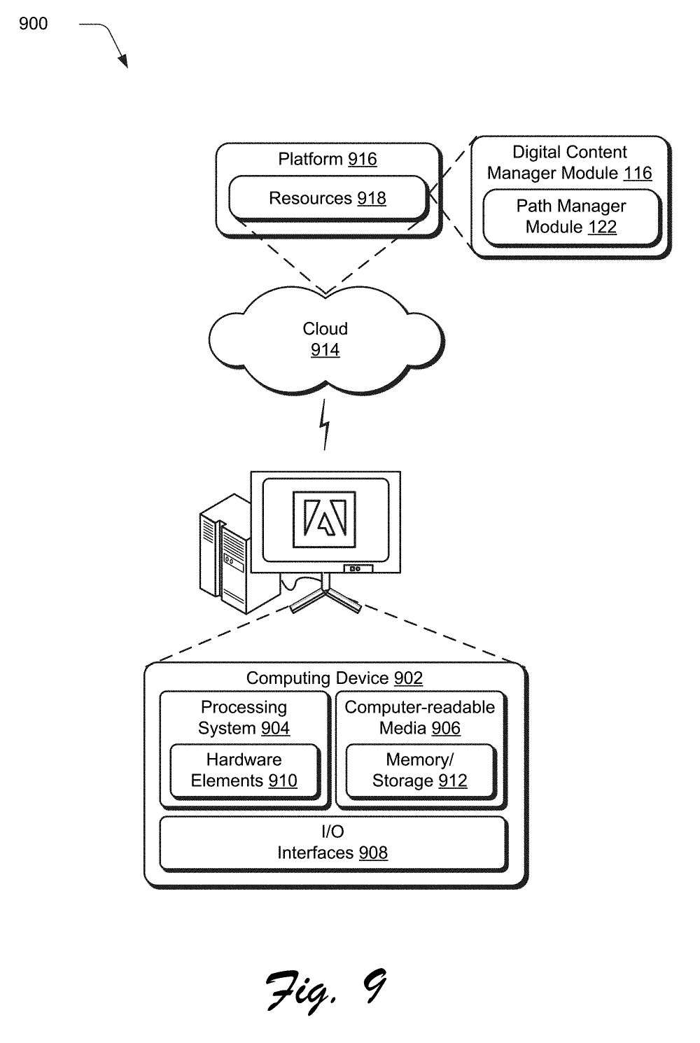

A computing device, for instance, may be configured as a desktop computer, a laptop computer, a mobile device (e.g., assuming a handheld configuration such as a tablet or mobile phone as illustrated), and so forth. Thus, the computing device may range from full resource devices with substantial memory and processor resources (e.g., personal computers, game consoles) to a low-resource device with limited memory and/or processing resources (e.g., mobile devices). Additionally, although a single computing device is shown, the computing device may be representative of a plurality of different devices, such as multiple servers utilized by a business to perform operations “over the cloud” as described in FIG. 9 and as illustrated for the service provider system 102.

The client device 104 is illustrated as associated with a user 108 in a physical environment 110. The client device 104, for instance, may be configured as a mobile phone, tablet, wearable (e.g., smart watch) or other configuration in which location of the client device 104, and thus the user 108, may be tracked within the physical environment 110. The client device 104, for instance, may include a position tracking device 112 (e.g., GPS tracker) that is configured to generate a time series of coordinates 114 that include a physical location of the user 108. In another example, the client device 104 is stationary at a physical location and the position tracking device 112 is configured to detect when the user 108 is at or near that location, e.g., as beacons within a store. Coordinates 114 from a series of such client devices 104 may then be used to track locations of the user 108 within the physical environment 110, either directly from the devices or indirectly through communication with a device on the person of the user 108.

The coordinates 114 in this example are communicated via the network 106 to the service provider system 102. The service provider system 102 includes a digital content manager module 116 that is implemented at least partially in hardware of a computing device to manage creation, storage, and/or communication of digital content 118, which is illustrated as stored in storage 120. Digital content 118 may take a variety of forms, including digital marketing content (e.g., online advertisements, banner ads), notifications, digital images, digital audio, augmented or virtual reality digital content, and so forth.

As part of management of the digital content 118, the digital content manager module 116 includes a path manager module 122. The path manager module 122 is implemented at least partially in hardware of a computing device (e.g., processing system and computer-readable storage media) to generate a path from the coordinates 114 and determine similarity of the path to other paths that serves as a basis to control output of the digital content 118.

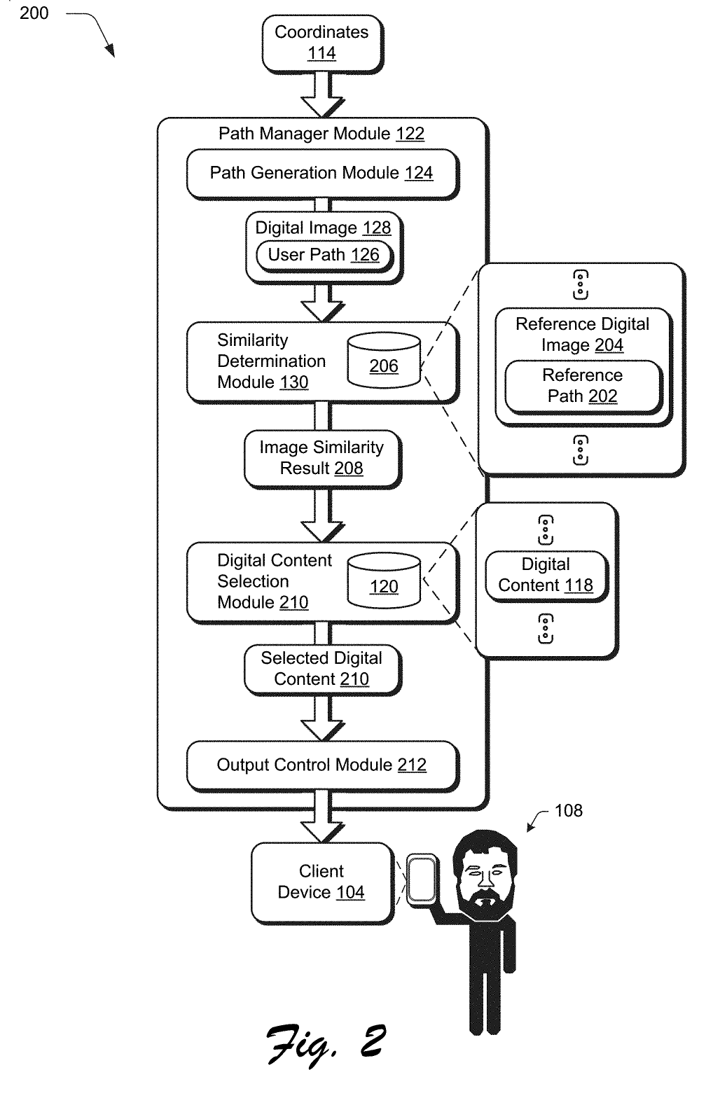

In one example, the path manager module 122 includes a path generation module 124. The path generation module 124 is configured to form a path 126 as part of a digital image 128 from the coordinates 114. The path 126 is described within the digital image 128 in that the transformation of the coordinates 114 into the path 126 is capable of being rendered for output, e.g., display in a user interface using a plurality of pixels. A variety of techniques may be used to generate the path 126 as described in greater detail in relation to FIG. 2.

The path manager module 122 also includes a similarity determination module 130. The similarity determination module 130 is implemented at least partially in hardware of a computing device (e.g., processing system and computer-readable storage media) to determine similarity of the path 126 with other paths to control which digital content 118 is selected for output to the user 108, e.g., via the client device 104. In one example, image similarity of the path 126 is used to correlate the user 108 with a segment of a user population and provide digital marketing content 118 based on that correlation, e.g., that has an increased likelihood of resulting in conversion. In another example, image similarity of the path 126 is used to determine a likely situation of the user 108 and provide appropriate digital content 118 to resolve that situation, e.g., to provide directions when lost. These and a variety of other examples are described in greater detail in the following.

In general, functionality, features, and concepts described in relation to the examples above and below may be employed in the context of the example procedures described in this section. Further, functionality, features, and concepts described in relation to different figures and examples in this document may be interchanged among one another and are not limited to implementation in the context of a particular figure or procedure. Moreover, blocks associated with different representative procedures and corresponding figures herein may be applied together and/or combined in different ways. Thus, individual functionality, features, and concepts described in relation to different example environments, devices, components, figures, and procedures herein may be used in any suitable combinations and are not limited to the particular combinations represented by the enumerated examples in this description.

Path Generation and Image Similarity

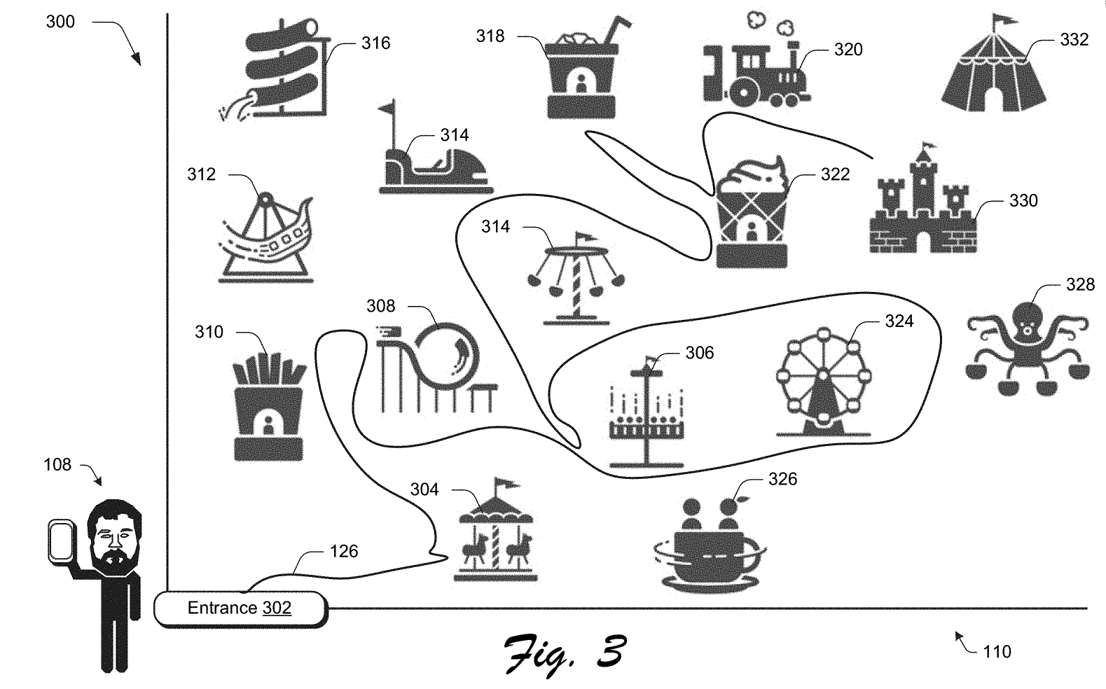

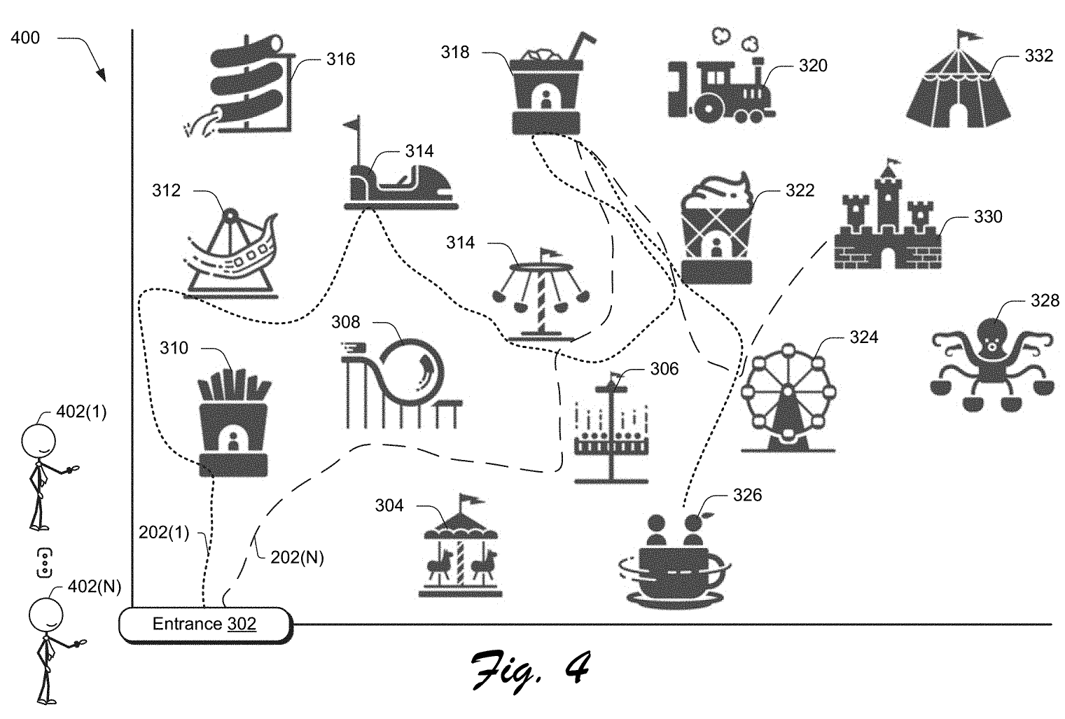

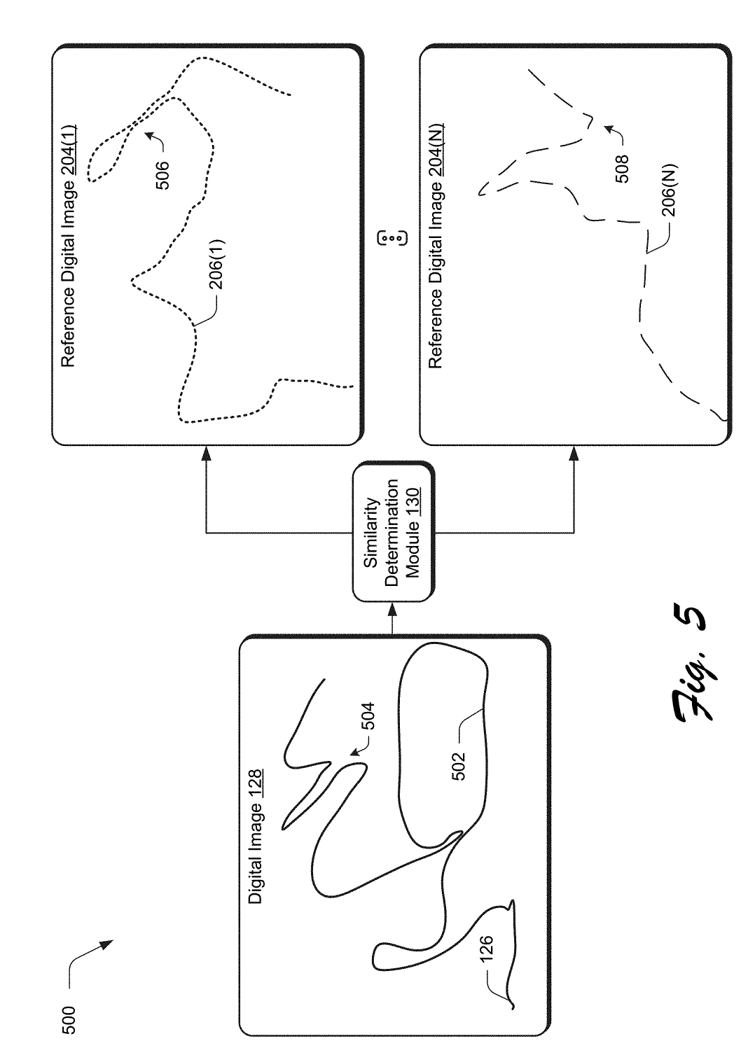

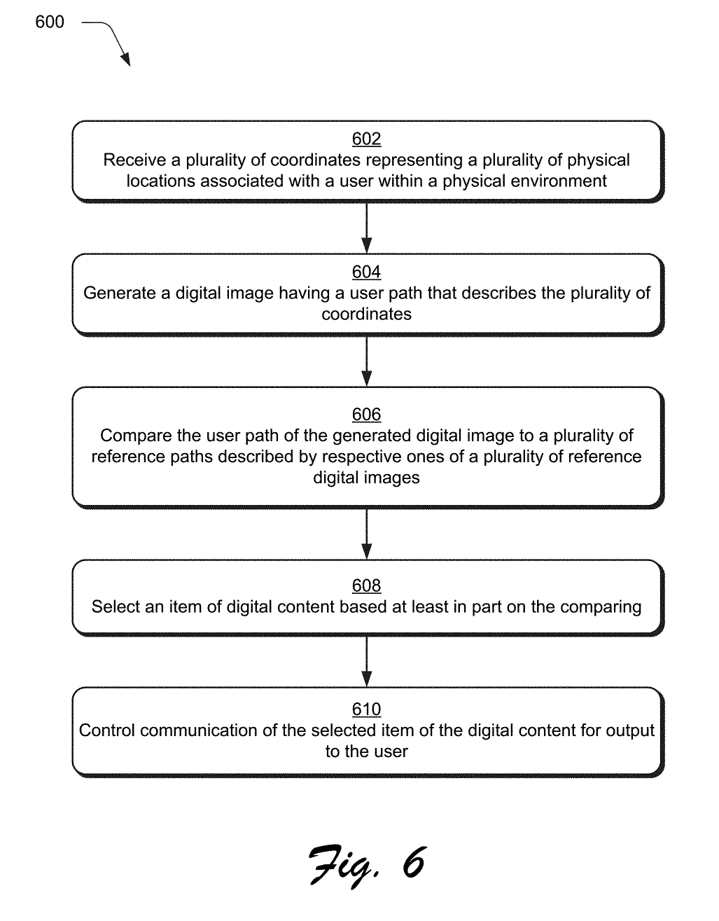

FIG. 2 depicts a system 200 in an example implementation showing operation of the path manager module 122 in greater detail as controlling output of digital content based on image similarity of a path to a plurality of reference paths. FIG. 3 depicts an example 300 of a physical journey taken by a user 108 through a physical environment 110 configured as an amusement park that serves as a basis to form the path in the digital image. FIG. 4 depicts an example implementation 400 of physical journeys taken by other users 402(1), 402(N) that serve as a basis to form reference paths that are compared to the path taken by the user 108 in FIG. 3. FIG. 5 depicts an example implementation 500 of image similarity comparisons performed by the similarity determination module 130 of FIG. 1 of the path to the reference paths. FIG. 6 depicts a procedure 600 in an example implementation in which output of digital content is controlled based on image similarity of a path to a plurality of reference paths.

The following discussion describes techniques that may be implemented utilizing the previously described systems and devices. Aspects of the procedure may be implemented in hardware, firmware, software, or a combination thereof The procedure is shown as a set of blocks that specify operations performed by one or more devices and are not necessarily limited to the orders shown for performing the operations by the respective blocks. In this section, reference is made interchangeably to FIGS. 2-6.

To begin, a plurality of coordinates 114 is received by the path manager module 124 that represent a plurality of physical locations associated with a user within a physical environment (block 602). The plurality of coordinates 114 may originate from a variety of sources. In one example, a client device 104 associated with a user 108 (e.g., a mobile phone, wearable device, tablet, and so forth) includes a position tracking device 112, such as a global positioning device, leveraging triangulation performed in conjunction with cell towers, dead reckoning techniques, and so forth. Coordinates 114 are generated by the position tracking device 112 in this example, which are then communicated to the service provider system 102 via the network 106. The user 108, for instance, may “opt in” through use of an application associated with the service provider system 102 to permit communication of these coordinates 114 by the client device 104 to the service provider system 102.

In another example, the coordinates 114 are obtained via a device that is not specifically associated with the user 108. Beacons, cameras, and other sensors, for instance, may be placed within the physical environment 110 and used to track movement of the user 108 through that environment without being disposed on the user 108. This movement is exposed as coordinates 114 to the service provider system 102, e.g., based on locations of the beacons and/or proximity to the beacons. Output of digital content 118 back to the user 108 in this example may be accomplished in a variety of ways, such as to the client device 104 disposed with the user 108, an output device positioned in the physical environment 110 that is not particular to the user 108 (e.g., a billboard, sign, audio speaker), and so forth as further described in greater detail below.

In the illustrated example, the coordinates 114 are obtained by a path generation module 124 and used to generate a digital image 128 having a user path 126 that describes the plurality of coordinates 114 (block 604). The coordinates 114, for instance, may describe a series of physical locations taken by the user 108 within the physical environment 110 over time, i.e., a time series of locations that describe physical movement of the user 108. These plurality of coordinates 114 may then be plotted and connected together by the path generation module 124 to form a path 126 in a digital image 128, e.g., definable by a generally continuous series of pixels. In another example, curve fitting techniques are employed by the path generation module 124 in which a curve or mathematical function is fit to a series of data points associated with the coordinates 114 that are used to define the path 126 in the digital image 128 which may then be rendered. A variety of other examples are also contemplated.

The path generation module 124 may also incorporate a variety of other functionality as part of generating the user path 126. In one example, the path generation module 124 is configured to “clean up” the user path by thickening a width of the defined user path to follow a width of an available physical pathway in the physical environment 110. In this way, variations along the physical pathway taken by users may be streamlined to efficiently describe intentional changes in direction and reduce small contours in the user path 126. This may be used to improve efficiency and accuracy in the determination of image similarity by the similarity determination module 130 by reducing a number of counters and simplifying an overall shape of the user path 126, thereby improving operation of the computing device.

The digital image 128 of the path 126 is then provided to a similarity determination module 130. The user path 126 of the generated digital image is compared by the similarity determination module 130 to a plurality of reference paths 202 described by respective ones of a plurality of reference digital images 204 (block 606), e.g., through image similarity. As used herein the digital image as including the respective path refers to all or a portion of a digital image file that includes a path. As such, multiple paths and corresponding digital images may be included within a file such that portions of the file that include paths are considered respective digital images. This is similar to how items of multiple clip art may be included within a continuous surface of a single file and be considered a collection of a plurality of digital images.

The similarity determination module 130 may employ a variety of different techniques to determine image similarity. Examples of techniques to determine image similarity include overlap shape detection and individual contour detection, such as fuzzy hashing, shape and line matching, and image moments, e.g., a weighted average known as a “moment” of intensities of pixels of a digital image which serves as a basis for comparison. This may be used to determine image similarity based on whether all or a portion of the path 126 of the digital image 128 has the same shape as a reference path 202 of the reference digital image.

In one example, paths may be determined as similar to each other regardless of where the path is generated in the physical environment 110. Accordingly, arrays may be generated by the similarity determination module 130 which describe contours of the user path 126 and reference paths 202 which may then be compared with each other, rather than comparing the images directly. In another example, the paths are cropped from the respective digital images and a pixel-by-pixel solution is employed to locate pixels that are “on” the path or “off” the path. The image is then redrawn to crop the digital image as defined by spans between the furthest left, right, top, and bottom pixels. The digital images may then be compared to determine similarity of the paths to each other with increased computational resource efficiency.

Thus, in this example the coordinates themselves are not used as a basis of image similarity, directly, but rather an overall appearance of all or a portion of a user path 126 formed from these coordinates 114. Further, this comparison may be performed independent of actual locations and thus may be used to support additional insight into a context of the user 108 as further described below.

An image similarity result 208 based on this comparison is then provided to a digital content selection module 210. The digital content selection module 210 is implemented at least partially in hardware of a computing device (e.g., a processing system and computer readable storage media) to select digital content 118 based on the comparison, i.e., the image similarity result 208 (block 608). For example, the reference path 202 of the reference digital image 204 may be associated with a segment of a user population. Thus, the digital content selection module 210 may select digital content 118 (e.g., digital marketing content) based on this identified segment of the user population that corresponds to the user 108, such as to increase likelihood of conversion of a good or service offered by the service provider system 102. In another example, the reference path 202 indicates that the user 108 is likely lost (e.g., repeating circular, zig-zagged, etc.) and then triggers the digital content selection module 210 to select digital content 118 that includes directions to a likely destination of the user.

As shown in the example of FIG. 3, for instance, the illustrated physical environment 110 includes an amusement park that includes an entrance 302 and a plurality of attractions 304-328. A user path 126 is generated by the path generation module 124 from coordinates 114 that describe the user's 108 journey through different locations within the amusement park and how the user journeyed between these locations. In the illustrated example, the user path 126 describes movement of the user 108 that begins at the entrance 302, continues to a carousel ride 304, past a food stand 310, loops back around to a rollercoaster 308, around both a freefall ride 306 and Ferris wheel 324, past a swing ride 314, back and forth between an ice cream stand 322 and refreshment stand 322, and continues to a castle 330. Thus, the user path 126 describes in this example a generally meandering path taken by the user 108 through the amusement park.

FIG. 4 also depicts an example 400 of the amusement park and associated attractions 304-328 along with reference paths 202(1), 202(N) taken by respective users 402(1), 402(N). The reference paths 202(1), 202(N) and subsequent interactions undertaken by the users 402(1), 402(N) are used as a basis to define different segments of a user population in this example. The segments then serve as a basis to target to target digital marketing content and thus the paths may be used to define different segments of the user population and employed to control digital content output to these segments.

For example, reference paths 202(1), 202(N) and associated interactions (e.g., good or services purchased) undertaken by respective users 402(1), 402(N) may indicate potential desires that may be common to a subsequent user that follows a similar path. Therefore, the digital content selection module 210 may select digital content 118 based on image similarity of the paths as likely indicative of similarity of desires and preferences of corresponding users. In one such example, the path 202(1) taken by a user 402(1) indicates that the user is likely hungry by passing by each attraction in the amusement park that offers food, e.g., the food stand 310, ice cream stand 318, and beverage stand 322. This likelihood may be bolstered by observance by the service provider system 102 of interactions taken by the user, e.g., to purchase food and services from one or more of these stands. Thus, this path 201(1) defines a segment of a user population that is likely hungry. The path 202(N) taken by another one of the plurality of users 402(N), however, does not indicate that the user is hungry (does not pass by food stands) and thus is not likely to be susceptible to advertisements regarding food or refreshments.

Consequently, the digital content selection module 210 may select digital content having advertisements for food for a subsequent user that follows a path that exhibits image similarity to path 204(1). As shown in FIG. 5, for instance, the user path 126 in the digital image 128 has increased image similarity (e.g., of an overall shape) to a reference path 206(1) in a reference digital image 204(1) than to a reference path 206(N) in reference digital image 204(N). Therefore, the digital content selection module 210 may determine that the user 108 is likely hungry and cause output of digital marketing content relating to goods and services involving food and beverages. In this way, the digital marketing content has an increased likelihood of being of interest to the user 108 and result in subsequent conversion, e.g., a purchase of food or beverages by the subsequent user.

Comparison of the paths using image similarity may also be used to infer context of the user regardless of a location at which the image path was generated. For example, a portion 502 of the user path 126 is circular in that it loops back toward itself. Thus, this portion 502 may indicate that the user 108 is likely lost, regardless of where this portion 502 occurred in the physical environment 110. Accordingly, a reference path 202 may be defined within a reference digital image 204 to indicate different reference paths 202 that are indicative of a user being lost, e.g., self-intersecting, looping, exhibiting a zig zag pattern, and so forth. The digital content selection module 210 may thus be triggered to select digital content 118 having directions to a destination that is likely of interest to the user 108 when found to be similar to one of these reference paths 202.

Comparison of the paths may also be used to infer characteristics about the physical environment that is a basis to form the paths. For example, paths 126, 206(1), and 206(N) each include corresponding portions 504, 506, 508 indicating back-and-forth movement in the amusement park between the beverage stand 322 and ice cream stand 318. This may be indicative that the corresponding users 108, 402(1)-402(N) are confused as to what is offered by these stands. A result of this indication as output in a user interface by the service provider system 102 may thus serve as a basis for an operator of the amusement park to change signage, food and beverage offerings, and so on to address this indicated confusion realized through path comparison and image similarity. This may also be used to output digital content for viewing by the users to counteract this confusion, such as to output available offerings from both stands when back and forth movement is detected through examination of the path in the digital image.

In another example, the similarity determination module 130 is configured to calculate scores indicative of a likely strength of intent of a user in reaching a particular location of a plurality of locations in the physical environment. The selected item of digital content is the based on this score based on the intent of the user in reaching a location. For example, the score may be indicative of how meandering or direct a path is that is take by a user from one location to another. The score may be calculated by the similarity determination module 140 in a variety of ways, such as based on a length of the path between the locations, a number of bends in the path (e.g., contour count), and so forth as indicative of a likely interest of the user in reaching a particular destination. Accordingly, the similarity determination module 130 may select an item of the digital content 118 that is associated with a particular location, to which, the user has exhibited interest based on directness of the path.

Returning again to FIG. 2, the selected digital content 210 is then provided to an output control module 212 that is configured to control output to the user (block 610). For example, the selected digital content 210 may be communicated to the client device 104 associated with the user 108 via the network 106 of FIG. 1, e.g., for output by a display device, speakers, and so forth. In another example, the selected digital content 210 is output by a client device 104 that is not particular to the user, such as a sign, via audio notification, and so forth. In this way, a context that is inferred based on image similarity of a path associated with a user to reference paths may be used to control selection and output of digital content. This may also be used to define segments and note deviations in expected user behavior, and example of which is described in the following section and shown in corresponding figures.

Path Synthesis and Image Similarity

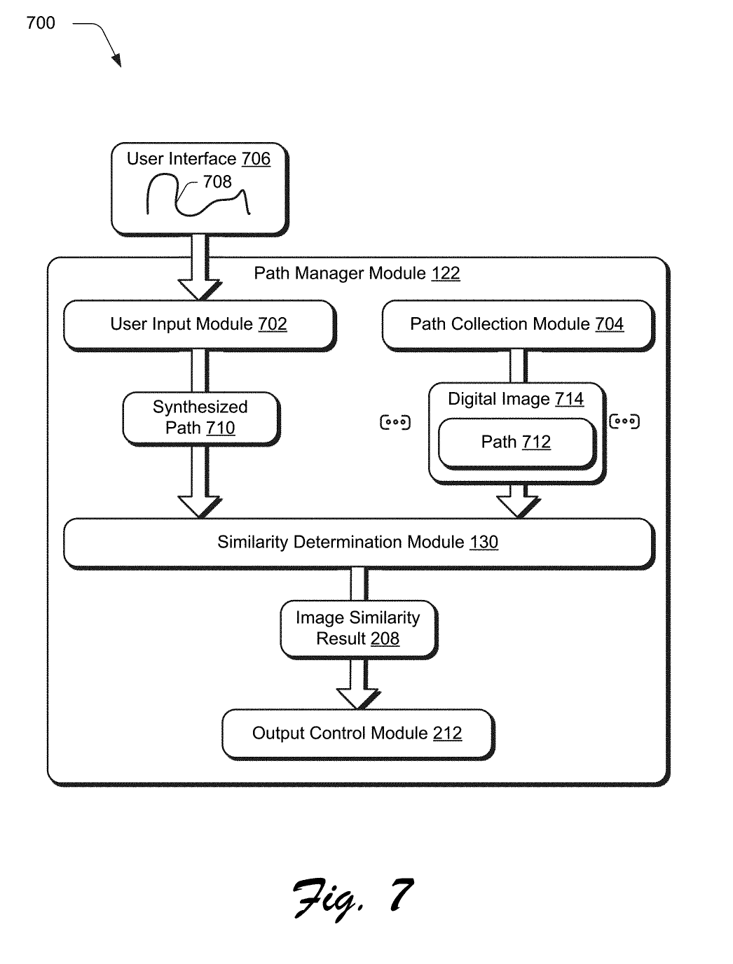

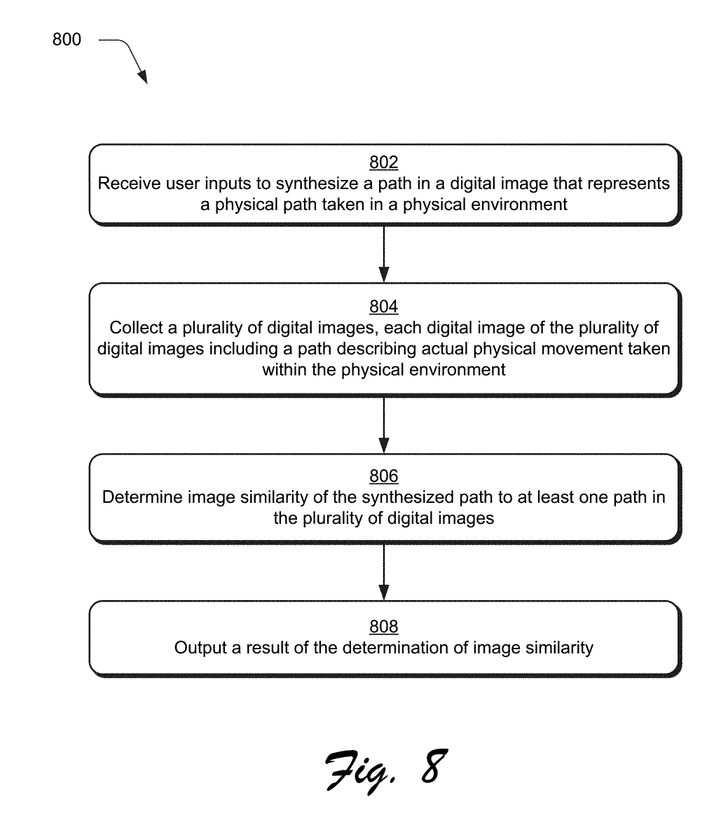

FIG. 7 depicts a system 700 in an example implementation in which a synthesized path is compared to paths taken of real world movement to determine image similarity, one to another. FIG. 8 depicts a procedure 800 in an example implementation in which a plurality of digital images is collected having paths that describe actual physical movement and compared with a synthesized path to determine image similarity.

The following discussion describes techniques that may be implemented utilizing the previously described systems and devices. Aspects of the procedure may be implemented in hardware, firmware, software, or a combination thereof The procedure is shown as a set of blocks that specify operations performed by one or more devices and are not necessarily limited to the orders shown for performing the operations by the respective blocks. In this section, reference is made interchangeably to FIGS. 7-8.

The definition of paths within a digital image may also be used to evaluate expected versus actual behavior of a user population. For example, the path manager module 122 may include a user input module 702 and a path collection module 704. The user input module 702 is configured to expose a user interface 706, via which, user inputs 708 are received to synthesize a path in a digital image that represents a physical path taken in a physical environment (block 802). A marketer, for instance, may draw a path over a map of a physical environment (e.g., amusement park) in the user interface 706 to define a segment of a user population that is to be subject of targeted digital marketing content. From these inputs, the user input module 702 generates the synthesized path 710 in a digital image, e.g., configured for rendering.

The path collection module 704 is implemented at least partially in hardware of a computing device to collect a plurality of digital images 714. Each digital image 714 of the plurality of digital images includes a path 712 describing actual physical movement taken within the physical environment (block 804). For example, the paths may correspond to movement of the users 401(1), 402(N) within the amusement park. This may be performed in a variety of ways as previously described for collection of coordinates in FIG. 1., such as through use of position tracking devices 112, beacons, and so forth.

Image similarity is determined by the similarity determination module 130 of the synthesized path 710 to at least one path 712 in the plurality of digital images 714 (block 806). As before, the image similarity may be determined in a variety of ways, such as fuzzy hashing, shape and line matching, and image moments, e.g., a weighted average known as a “moment” of intensities of pixels of a digital image which serves as a basis for comparison.

The similarity determination module 130 then outputs an image similarity result 208, which is output by the output control module 212 (block 808). The marketer that provided the user inputs 708 via the user interface 706, for instance, may view the image similarity result 208 to determine effectiveness of a marketing strategy based on image similarity of the synthesized path 710 to the paths 712 in the digital images 714. In another example, the user inputs 708 may be used to define a segment of a user population and determine whether users in the real world exhibit behaviors consistent with that segment. A variety of other examples are also contemplated, such as to select specific users and user paths that exhibit intended or unintended behavior and determine whether other users have exhibited similar behaviors.

Example System and Device

FIG. 9 illustrates an example system generally at 900 that includes an example computing device 902 that is representative of one or more computing systems and/or devices that may implement the various techniques described herein. This is illustrated through inclusion of the digital content manager module 116 and path manager module 122. The computing device 902 may be, for example, a server of a service provider, a device associated with a client (e.g., a client device), an on-chip system, and/or any other suitable computing device or computing system.

The example computing device 902 as illustrated includes a processing system 904, one or more computer-readable media 906, and one or more I/O interface 908 that are communicatively coupled, one to another. Although not shown, the computing device 902 may further include a system bus or other data and command transfer system that couples the various components, one to another. A system bus can include any one or combination of different bus structures, such as a memory bus or memory controller, a peripheral bus, a universal serial bus, and/or a processor or local bus that utilizes any of a variety of bus architectures. A variety of other examples are also contemplated, such as control and data lines.

The processing system 904 is representative of functionality to perform one or more operations using hardware. Accordingly, the processing system 904 is illustrated as including hardware element 910 that may be configured as processors, functional blocks, and so forth. This may include implementation in hardware as an application specific integrated circuit or other logic device formed using one or more semiconductors. The hardware elements 910 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions.

The computer-readable storage media 906 is illustrated as including memory/storage 912. The memory/storage 912 represents memory/storage capacity associated with one or more computer-readable media. The memory/storage component 912 may include volatile media (such as random access memory (RAM)) and/or nonvolatile media (such as read only memory (ROM), Flash memory, optical disks, magnetic disks, and so forth). The memory/storage component 912 may include fixed media (e.g., RAM, ROM, a fixed hard drive, and so on) as well as removable media (e.g., Flash memory, a removable hard drive, an optical disc, and so forth). The computer-readable media 906 may be configured in a variety of other ways as further described below.

Input/output interface(s) 908 are representative of functionality to allow a user to enter commands and information to computing device 902, and also allow information to be presented to the user and/or other components or devices using various input/output devices. Examples of input devices include a keyboard, a cursor control device (e.g., a mouse), a microphone, a scanner, touch functionality (e.g., capacitive or other sensors that are configured to detect physical touch), a camera (e.g., which may employ visible or non-visible wavelengths such as infrared frequencies to recognize movement as gestures that do not involve touch), and so forth. Examples of output devices include a display device (e.g., a monitor or projector), speakers, a printer, a network card, tactile-response device, and so forth. Thus, the computing device 902 may be configured in a variety of ways as further described below to support user interaction.

Various techniques may be described herein in the general context of software, hardware elements, or program modules. Generally, such modules include routines, programs, objects, elements, components, data structures, and so forth that perform particular tasks or implement particular abstract data types. The terms “module,” “functionality,” and “component” as used herein generally represent software, firmware, hardware, or a combination thereof. The features of the techniques described herein are platform-independent, meaning that the techniques may be implemented on a variety of commercial computing platforms having a variety of processors.

An implementation of the described modules and techniques may be stored on or transmitted across some form of computer-readable media. The computer-readable media may include a variety of media that may be accessed by the computing device 902. By way of example, and not limitation, computer-readable media may include “computer-readable storage media” and “computer-readable signal media.”

“Computer-readable storage media” may refer to media and/or devices that enable persistent and/or non-transitory storage of information in contrast to mere signal transmission, carrier waves, or signals per se. Thus, computer-readable storage media refers to non-signal bearing media. The computer-readable storage media includes hardware such as volatile and non-volatile, removable and non-removable media and/or storage devices implemented in a method or technology suitable for storage of information such as computer readable instructions, data structures, program modules, logic elements/circuits, or other data. Examples of computer-readable storage media may include, but are not limited to, RAM, ROM, EEPROM, flash memory or other memory technology, CD-ROM, digital versatile disks (DVD) or other optical storage, hard disks, magnetic cassettes, magnetic tape, magnetic disk storage or other magnetic storage devices, or other storage device, tangible media, or article of manufacture suitable to store the desired information and which may be accessed by a computer.

“Computer-readable signal media” may refer to a signal-bearing medium that is configured to transmit instructions to the hardware of the computing device 902, such as via a network. Signal media typically may embody computer readable instructions, data structures, program modules, or other data in a modulated data signal, such as carrier waves, data signals, or other transport mechanism. Signal media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

As previously described, hardware elements 910 and computer-readable media 906 are representative of modules, programmable device logic and/or fixed device logic implemented in a hardware form that may be employed in some embodiments to implement at least some aspects of the techniques described herein, such as to perform one or more instructions. Hardware may include components of an integrated circuit or on-chip system, an application-specific integrated circuit (ASIC), a field-programmable gate array (FPGA), a complex programmable logic device (CPLD), and other implementations in silicon or other hardware. In this context, hardware may operate as a processing device that performs program tasks defined by instructions and/or logic embodied by the hardware as well as a hardware utilized to store instructions for execution, e.g., the computer-readable storage media described previously.

Combinations of the foregoing may also be employed to implement various techniques described herein. Accordingly, software, hardware, or executable modules may be implemented as one or more instructions and/or logic embodied on some form of computer-readable storage media and/or by one or more hardware elements 910. The computing device 902 may be configured to implement particular instructions and/or functions corresponding to the software and/or hardware modules. Accordingly, implementation of a module that is executable by the computing device 902 as software may be achieved at least partially in hardware, e.g., through use of computer-readable storage media and/or hardware elements 910 of the processing system 904. The instructions and/or functions may be executable/operable by one or more articles of manufacture (for example, one or more computing devices 902 and/or processing systems 904) to implement techniques, modules, and examples described herein.

The techniques described herein may be supported by various configurations of the computing device 902 and are not limited to the specific examples of the techniques described herein. This functionality may also be implemented all or in part through use of a distributed system, such as over a “cloud” 914 via a platform 916 as described below.

The cloud 914 includes and/or is representative of a platform 916 for resources 918. The platform 916 abstracts underlying functionality of hardware (e.g., servers) and software resources of the cloud 914. The resources 918 may include applications and/or data that can be utilized while computer processing is executed on servers that are remote from the computing device 902. Resources 918 can also include services provided over the Internet and/or through a subscriber network, such as a cellular or Wi-Fi network.

The platform 916 may abstract resources and functions to connect the computing device 902 with other computing devices. The platform 916 may also serve to abstract scaling of resources to provide a corresponding level of scale to encountered demand for the resources 918 that are implemented via the platform 916. Accordingly, in an interconnected device embodiment, implementation of functionality described herein may be distributed throughout the system 900. For example, the functionality may be implemented in part on the computing device 902 as well as via the platform 916 that abstracts the functionality of the cloud 914.

Conclusion

Although the invention has been described in language specific to structural features and/or methodological acts, it is to be understood that the invention defined in the appended claims is not necessarily limited to the specific features or acts described. Rather, the specific features and acts are disclosed as example forms of implementing the claimed invention.

What is claimed is:

1. In a digital medium to control provision of digital content based a plurality of coordinates in a physical environment, a method implemented by at least one computing device, the method comprising:
receiving, by the at least one computing device, the plurality of coordinates generated by a position determining device, the plurality of coordinates representing a plurality of physical locations within the physical environment;
generating, by the at least one computing device, a digital image having a path based on the plurality of coordinates;
determining, by the at least one computing device, image similarity of the path of the generated digital image to a plurality of reference paths described by respective ones of a plurality of reference digital images;
identifying, by the at least one computing device, at least one reference path of the plurality of reference paths as corresponding to the path based on the determined image similarity;
selecting, by the at least one computing device, an item of digital content that is associated with the identified at least one reference path; and
controlling, by the at least one computing device, output of the selected item of the digital content.

2. The method as described in claim 1, wherein the plurality of coordinates originates from the position determining device as included as part of a client device disposed with a user and the controlling causes communication of the selected item of the digital content for output by the client device.

3. The method as described in claim 1, wherein the digital content is configured to include directions or digital marketing content.

4. The method as described in claim 1, wherein the determining is based on image similarity of the path in the digital image to the plurality of reference paths described by the plurality of reference digital images using contour detection.

5. The method as described in claim 1, wherein the determining is performed independent of actual physical locations in the physical environment of the user path and the plurality of reference paths.

6. The method as described in claim 1, wherein the determining is based on image similarity of the path in the digital image to the plurality of reference paths described by the plurality of reference digital images using overlap shape detection.

7. The method as described in claim 1, wherein the identifying indicates that the path indicates a lost user and the selected digital content includes directions.

8. The method as described in claim 1, wherein the generating includes assigning the path in the digital image to have a width that corresponds to a width of a physical pathway within the physical environment.

9. The method as described in claim 1, wherein:
the selecting includes calculating a score indicative of a likely strength of a user's intent in reaching each location of a plurality of locations in the physical environment;
the selected item of digital content is one of a plurality of items of digital content;
each item of digital content of the plurality of items of digital content is associated with a respective location within the physical environment; and
the item of digital content is selected from the plurality of items of digital content based on the score.

10. The method as described in claim 1, wherein the determining and the selecting are performed using machine learning.

11. The method as described in claim 1, wherein the path is drawn in the digital image as a freeform line.

12. In a digital medium to determine image similarity of paths, a system comprising:
a user input model implemented at least partially in hardware of a computing device to receive user inputs to synthesize a path in a digital image that represents a physical path taken in a physical environment;
a path collection module implemented at least partially in hardware of a computing device to collect a plurality of digital images, each digital image of the plurality of digital images including a path describing actual physical movement taken within the physical environment;
a similarity determination module implemented at least partially in hardware of the computing device to determine image similarity of the synthesized path to at least one said path in the plurality of digital images; and
an output control module implemented at least partially in hardware of the computing device to output a result of the determination of image similarity.

13. The system as described in claim 12, wherein the user input module is configured to output a map of the physical environment in a user interface, via which, the user inputs are received that specify the path to be synthesized.

14. The system as described in claim 12, wherein image similarity is independent of actual physical locations in the physical environment.

15. The system as described in claim 12, wherein the image similarity is based at least in part on overlap shape detection or individual contour detection.

16. The system as described in claim 12, wherein the path collection module is configured to:
receive a plurality of coordinate collections, each coordinate collection of the plurality of coordinate collections representing a plurality of physical locations associated with a respective user of a plurality of users within the physical environment; and
generate the plurality of digital images from the plurality of coordinate collections.

17. In a digital medium to control provision of digital content based a plurality of coordinates associated with a physical environment, a system comprising:
means for generating a digital image having a path that describes the plurality of coordinates, the plurality of coordinates representing a plurality of physical locations within the physical environment;
means for determining image similarity of the path of the generated digital image to a plurality of reference paths described by respective ones of a plurality of reference digital images;
means for selecting an item of digital content based at least in part on the determined image similarity; and
means for controlling output of the selected item of the digital content.

18. The system as described in claim 17, wherein the plurality of coordinates originates from a position determining device of a client device disposed with a user and the controlling causes communication of the selected item of the digital content for output by the client device to the user.

19. The system as described in claim 17, wherein the image similarity is independent of actual physical locations in the physical environment of the user path and the plurality of reference paths.

20. The system as described in claim 17, wherein the image similarity is based at least in part on overlap shape detection or individual contour detection.
